(19) United States
(12) Patent Application Publication
(10) Pub. No.: US 2013/0013351 A1
(43) Pub. Date: Jan. 10, 2013

(54) INVENTORY SYSTEM AND METHOD THEREFOR

(75) Inventors: Umit Murad Cholak, Atlanta, GA (US); Metin Gursel Ozisik, Atlanta, GA (US)

(73) Assignee: SITA INFORMATION NETWORKING COMPUTING UK LIMITED, Hayes (GB)

(21) Appl. No.: 13/363,045

(22) Filed: Jan. 31, 2012

Related U.S. Application Data
(60) Provisional application No. 61/438,186, filed on Jan. 31, 2011.

(30) Foreign Application Priority Data
Jun. 1, 2011 (GB) GB 1109242.6
Jan. 27, 2012 (EP) PCT/EP2012/051386

(51) Int. Cl. G06Q 10/02

(52) U.S. Cl. 705/5

(57) ABSTRACT

An inventory control system is disclosed. The system comprises: an inventory server for storing inventory parameters defining one or more products; an availability server arranged to receive an availability request for a product; broadcasting means for broadcasting updated inventory parameters from the inventory server to the availability server; wherein the availability server determines the availability of the requested product by comparing one or more product parameters to one or more inventory parameters in response to the availability server receiving an availability request.

### CROSS-REFERENCE TO RELATED APPLICATIONS

This application claims the benefit under 35 U.S.C. §119(e) of U.S. Provisional Patent Application No. 61/438,186, filed Jan. 31, 2011, and entitled “INVENTORY SYSTEM AND METHOD THEREFOR”, which is incorporated by reference as if set forth herein in its entirety. This application further claims the benefit of and priority to co-pending Patent Cooperation Treaty (PCT) Application No. PCT/EP2012/051386, filed Jan. 27, 2012, and entitled “INVENTORY SYSTEM AND METHOD THEREFOR”, and Great Britain Patent Application No. GB 1109242.6, filed Jun. 1, 2011, and entitled “INVENTORY SYSTEM AND METHOD THEREFOR”, both of which are incorporated by reference as if set forth herein in their entireties.

### FIELD OF THE INVENTION

This invention relates to an inventory control system. Further, this invention also relates to an inventory control system for use by a merchant, and in particular to an inventory control system for use by an airline.

### BACKGROUND OF THE INVENTION

In order to manage availability of seats on a scheduled flight between two airports, airlines use an inventory control system. The inventory of seats on a flight is divided by the passenger demand characteristics into different market segments for Revenue Management (RM) purposes in order to maximize the potential revenue generated by the entire seat capacity available in that market.

Airlines usually store their inventory on a Computerized Reservation System (CRS). The CRS allows airlines to store and retrieve inventory information and also perform air travel transactions. There are a number of known CRSs provided by third parties which provide inventory hosting services for airlines. Some airlines, however, prefer to have their own dedicated CRS which they use to manage their inventory. Revenue Management (RM) policies for an airline are executed by an Inventory Control mechanism in the CRS. The Inventory Control mechanism is usually an integral part of the CRS.

Regardless of the RM practices employed by an airline, an airline's inventory must be distributed to potential travellers though a distribution channel. Airlines that cannot distribute their inventory to potential travellers cannot be competitive. Therefore, airlines use one or more distribution channels to reach to potential travellers. The most common distribution channels are:
a) Global Distribution System (GDS). This offers capability to distribute travel content to large number of Travel Agencies that participate with a particular GDS. A GDS tes or sends transactions from a Travel Agency to a particular CRS. Some GDSs, such as Sabre, also include a CRS as well as a GDS. However, these are usually managed as two different business processes.
b) Airline web sites. These provide direct access to an airline's inventory by bypassing the GDS. This is a preferred method for inventory content distribution for airlines since it eliminates the GDS costs;
c) Online Travel Agencies (OTA). The OTAs consolidate large amount of travel content and is usually partnered with a GDS. They also have the capability to bypass GDS to access an airline's CRS directly; and
d) Airline Call Centres. These are also another preferred method of distribution for airlines as it saves an airline significant GDS costs.

In all cases, an airlines' Inventory Control system is the only tool that can determine the actual availability of seats regardless of the how the availability request is generated and channel with which the availability request is distributed.

Inventory distribution channels such as GDSs which do not include a CRS must forward a seat availability request to an airline's Inventory Control system. The inventory control system then determines if there are any available seats to offer for all the fare classes valid in that market. This type of availability request is commonly known as seamless access.

Two different types of seamless access exist: direct access and direct connect. Each type of seamless access provides different services to the airlines at different cost. However, what is common in seamless access is the forwarding of one form of availability request to the CRS where the Inventory is hosted. Making seamless availability requests from a GDS to the Inventory Control System has the following problems.

Firstly, there is a significant cost to the airline for those high volume availability transactions. Secondly, the transaction response time usually takes too long because it travels though different systems and a Wide Area Network (WAN). Thirdly, seamless availability is sometimes not offered by some distribution channels. Finally, seamless access requires bi-lateral agreements between airlines and GDSs. In summary, seamless access suffers from limited availability, high cost and slow response times.

One known solution to these problems is to use Availability Status (AVS) or Availability Numeric (AVN) messages. AVS indicates the open or closed status of a booking class on a leg or segment while AVN indicates the number of seats still available for sale on a fare class on a leg or segment of a flight. Inventory Control Systems either periodically or after every sell and cancel, create a new AVS or AVN message. This is then sent to one or more distribution channels. Those channels resolve the availability question locally using the AVS or AVN message without resorting to Seamless Availability transactions.

In this way, the use of AVS or AVN messages reduces the number of seamless transactions sent from the distribution channel to the Inventory Control System. It also improves the response time and reduces transaction costs.

However, one problem with using AVS or AVN messages is that this results in reduced availability accuracy. Depending on the Inventory Control strategies of the airlines there are many factors which may contribute the reduced availability accuracy.

A further problem arises when online booking activity increases. Online booking activity has increased in recent years in part due to the use of automated shopping tools by consumers. As online booking activity increases, the look-to-book ratio (i.e. the number of seat availability request messages received for every sell transaction) increases significantly. This ratio is around 200:1 in the US, and is more than 400:1 in Europe. It may be as high as 2000:1 in the Far East.

In order to deal with the large number of availability request messages, there are different solutions offered in the industry in addition to AVS or AVN messages. These are:

Proxy: This method has proved to be the most accurate way of providing availability answers outside the real inventory control system. However it is rather expensive to deliver and maintain. It must be implemented one airline at time, and it requires cooperation from the airline, their current Inventory Control solution provider, and their Revenue Management System provider. Proxy replicates the inventory control logic outside the Inventory Control System. There are very few proxies in the world today, and they are available only for the large airlines because the cost of delivery is prohibitive and it is not justified to make the investment for small airlines. The cost of the investment is usually borne by the distribution channel that benefits from correct availability, however, the amount of the investment may not be justified by the benefits of developing proxy for smaller airlines.

Cache: Different distribution channels and large online Travel Agencies have developed a local database where they keep the old availability answers from the Inventory Control System. These are rather high performance and highly saleable systems. However, this method of storing old answers for a future use frequently generates incorrect answers. Even though it meets the high volume demand, it fails to provide accurate availability answers. The accuracy of cache solution depends on the Inventory Control logic used by the airlines and CRSs. The accuracy of cache is reduced significantly by Point of Sale (POS) based inventory control logic or the cost of development and management is increased by Origin-Destination (OD) based inventory control described above.

Point of Sale: POS based control provides different availability answers based on many parameters such as where the request is coming from, distribution channel, country, Travel Agency, the customer profiles, request time, number of days from departure, and so on. It becomes impossible to store the availability answer for all the combinations of the attributes impacting the availability decision at the source of the inventory control. A Cache stores an availability intended for a specific travel agency and potentially uses it for another one. It is impossible for the cache systems to know the level of POS control employed at the Inventory Control. OD has a similar impact on the cache systems. It requires storing the answers at OD and POS combination level. This increases the hardware requirements to store large amount of data and complicates the logic determining how to refresh the data.

### SUMMARY OF THE INVENTION

The invention aims to address these problems by providing a distributed inventory system and method by providing seat inventory availability locally so that the need to rely on local AVS or AVN messages, proxy or cache based solutions is eliminated.

Embodiments of the invention achieve this by deploying availability services on dedicated servers in an availability grid in such a way that availability nodes or servers are located in locations where the availability service is needed. Preferably, each node or server communicates with the rest of the inventory system over a Wide Area Network (WAN) or Local Area Network (LAN) in real time with minimal delay associated with the network.

According to a first aspect of the present invention there is provided an inventory control system comprising an inventory server for storing inventory parameters defining one or more products; an availability server arranged to receive an availability request for a product; broadcasting means for broadcasting updated inventory parameters from the inventory server to the availability server; wherein the availability server determines the availability of the requested product by comparing one or more product parameters to one or more inventory parameters in response to the availability server receiving an availability request.

Preferably, the availability server is logically separated from the inventory server, and in particular, the availability server is in a different location to the inventory server.

Preferably, the inventory control system further comprises one or more additional availability servers each arranged to receive a or the availability request and in particular to determine the availability of a product by comparing one or more product parameters to one or more inventory parameters in response to one of the availability servers receiving an availability request.

Preferably, the availability server or servers further comprise one or more grid nodes. Preferably, each grid node comprises a grid memory.

Preferably, the availability request is routed via one of the grid nodes in dependence upon the content of the availability request.

Preferably, at least some of the grid nodes are located on different availability servers.

Preferably, each grid memory stores one or more inventory parameters of the most recent availability request received by the grid node.

Preferably, each grid memory stores at least some inventory parameters which are different from the inventory parameters stored in the other grid memories.

Preferably, the inventory parameters are sent from the inventory server to one of the grid memories if the inventory parameters of the requested product are not stored in the grid memory or are not the most up to date parameters.

Preferably, the inventory parameters are routed to one of the grid memories in dependence upon the content of the availability request.

Preferably, the inventory control system further comprises an updating means arranged to asynchronously update the inventory parameters stored in the inventory server and the inventory parameters stored in one of the grid memories. For example, the updating means may update the inventory parameters stored in the inventory server and the inventory parameters stored in one of the grid memories at different times. In one example, the updating means starts updating the inventory parameters stored in the inventory server and then starts updating the inventory parameters stored in one of the grid memories. Alternatively, the updating means starts updating the inventory parameters stored in one of the grid memories and then starts updating the inventory parameters stored in the inventory server. In this example, the updating of the inventory parameters stored in one of the grid memories and the updating of the inventory parameters stored in the inventory server may overlap in time. In a further example, the updating means may complete the updating of the inventory parameters stored in the inventory server may be and then update the inventory parameters stored in the grid memories. For example, the updating of the inventory parameters store in one of the grid memories and the updating of the inventory parameters stored in the inventory server may not overlap in time.

Preferably, the updating means first updates the data stored in one of the grid memories and then the inventory parameters stored in the inventory server if a sell or cancel transaction is received by one of the inventory server.

Preferably, the updating means first updates the inventory parameters stored in the inventory server and then the data stored in one of the grid memories if the inventory server receives bid price data or schedule connection data or fare data or business rule data.

Preferably, the system comprises one or more processing servers for receiving a request and in particular for determining the type of request.

Preferably, the inventory server is logically or physically or both logically and physically separated from the availability server.

Preferably, the system further comprises one or more additional inventory servers.

Preferably, the inventory parameters are partitioned across the inventory servers such that each inventory server stores at least some inventory parameters which are different from the inventory parameters stored on the other server.

Preferably, one inventory server is a fail-over server for the other inventory server. The fail-over server may store a copy of the inventory parameters stored on the other inventory server.

Preferably, one of the processing servers only routes the request to one of the grid nodes if the request is an availability request.

Preferably, one of the processing servers routes a request to the inventory server if the request is a sell or cancel request.

Preferably, the product parameters are compared with updated inventory parameters.

Preferably, the system further comprising one or more additional fail-over servers.

Preferably, the availability server is logically separated from the inventory server. Further preferably, each availability server is logically or physically or both logically and physically separated from the other availability servers.

The architecture of embodiments of the invention allows an availability calculation to be performed at local availability servers by distributing parameters to the local availability servers over the WAN or LAN or other communication means. This means that availability node or servers may be placed where they are needed instead of all the availability transactions coming to a centrally located inventory system. Providing correct availability locally eliminates the need to rely on local AVS or cache based availability solutions. Reducing AVS transmissions for the same channel where the availability node is deployed provides further cost savings for the airline. More importantly, accurate availability answers are generated, and revenue is increased by increasing availability accuracy. The availability server may be configured to only process availability requests.

Embodiments of the invention have a number of advantages. Firstly, embodiments are highly scalable to handle increased shopping volume. This is achieved by reducing disk input or output (I/O) by storing the most frequently used data is in a grid memory. Secondly embodiments of the invention operate with reduced levels of seamless availability traffic.

Preferably, embodiments of the invention eliminate the need for seamless availability traffic. This avoids the need for generation and distribution of AVS or AVN for distribution channels which have to forward seat availability requests to an inventory control system.

Preferably, inventory data for flights up to approximately 1 month before departure is stored in the grid memory. By keeping this data for the last month of booking activity in grid memory, this reduces the memory requirements and disk I/O by more than 90%.

Thirdly, embodiments of the invention may partition inventory data in one or more routing grid nodes. This allows availability requests to be routed to one of a plurality of the grid nodes thereby allowing availability calculations to be scaled up largely independently from the sell transactions. This means that increased processing power can be provided for the large numbers of availability requests, whilst not necessarily increasing the capacity for processing sell requests. This has the advantage that accurate availability calculations can be quickly performed and returned to a user requesting the availability.

Preferably, embodiments of the invention use sell transactions, which are harder to scale up, which are loosely coupled with availability transactions. This allows availability transactions to be scaled up independently from the sell transactions.

The separation of sell and availability services allows embodiments of the invention to scale the sell or cancel service separately and independently from the availability service. Again, this allows scalability of the availability services separately from the sell services, without getting blocked or slowed-down by sell transactions. As availability transactions are read-only services, they do not require synchronization, locking any database records, or any database updates. Therefore embodiments of the invention are not inhibited by the limitations that impact sell services. The architecture according to embodiments of the invention allows availability services to be scaled up at much higher rate and independently from sell services.

This is in contrast to legacy systems which cannot scale up enough to meet the shopping demand created by the high look-to-book ratio due to automated systems. This is because legacy systems have a monolithic inventory control service. In such legacy systems, scaling up availability functions provided by the inventory requires scaling up all the functions provided within that inventory system. Therefore, embodiments of the invention may deploy a number of availability servers which is greater than the number of servers supporting the main inventory system.

This is because the need to scale up sell transactions is significantly less than that of availability transactions. This is a result of the fact that even though the volume of people travelling in the world is increasing, and in turn number of sell transaction volume is increasing, this increase is much less than the increase in availability transactions. As such, the inventors have appreciated that sell transactions do not need to be scaled up as much as availability transactions.

Further, the inventors have appreciated that the sell and availability transactions impose different requirements on the inventory system. Sell transactions are more resource intensive: They require locking the database record for every transaction and require a database update for every transaction. Therefore, they are expensive to scale up, lengthier in execution-time, and have a blocking nature for other types of requests.

Further, embodiments of the invention provide accurate availability calculations. This is because embodiments of the invention run complete availability calculations for every availability request instead of relying on stale answers which have been cached from a previous response. Consequently the result of the availability calculation will reflect any impact of any potential changes in the Point of Sale (POS) controls, seat sold count, bid price, fares, and so on. In this way, embodiments of the invention provide accurate availability regardless of the inventory control logic such as OD controls and rules.

Being able to provide accurate availability where it is needed helps airlines save cost associated with the large number of availability requests received due to high traffic volume.

Furthermore, embodiments of the inventions can be implemented on commodity servers with no specialized hardware (HW), thereby reducing hardware costs and in turn, implementation costs for embodiments of the invention.

Embodiments of the invention are also highly reliable. This is a result of the underlying grid architecture of embodiments of the invention. In the grid, if any of the nodes or servers fails, one of the other nodes or servers assumes the role of the failed server or node. This design permits the system to continue functioning provided there is at least one operational server or node.

The entire inventory system according to embodiments of the invention may be deployed on a grid of many computers or servers based on the high-volume needs of an airline. Sell and availability services may be logically separated. Nevertheless, the sell and availability services may be deployed on the same computer or server. Thus, as long as at least one computer remains standing in the grid, both availability and sell services are available. However, the ability to separate the availability and sell services logically also allows sell and availability services to be deployed on physically separate computers or servers in the inventory grid. This is an important technical feature of the solution appreciated by the inventors.

Further, in prior art inventory systems, a large quantity of data is input to and output from (I/O) from the inventory server. Such systems are burdened with heavy disk I/O and try to optimize it by utilizing caches such as distributed caches in multi-node clusters. Such systems often end-up reducing disk I/O but have increased network I/O instead. This means that prior art solutions tend to approach the limits of network bandwidth, and often saturate their networks meaning that they are suitable for small-scale applications only.

Embodiments of the invention avoid these problems by optimising both disk and network input and output. I/O is optimized by firstly having most recently used availability data stored in memory referred to as a grid memory, thereby reducing disk I/O. If the data needed is not in the grid memory or data in the grid memory is no longer up to date, it is retrieved from storage such as a hard disk and loaded into the grid memory.

In some embodiments, the availability server is configured to perform an availability request and not a sell request for a product and preferably, the inventory server is configured to perform both sell and availability requests.

In some embodiments, the inventory server is communicatively coupled to the availability server in real time via a network such as a Wide Area Network or a Local Area Network.

In some embodiments, a plurality of availability servers are provided for performing an availability request and not a sell request.

In some embodiments, a distribution server, for example an airline server, or a call centre server or a city ticket office server, is provided. The availability server and the distribution server are provided on a single server such that distribution server communicatively coupled to the availability server without using a network.

### BRIEF DESCRIPTION OF THE DRAWINGS

Embodiments of the invention will now be described, by way of example only, and with reference to the accompanying drawings, in which:

FIG. 1 shows a schematic representation of a system embodying the invention;

FIG. 2 is a schematic diagram showing how inventory data is partitioned according to embodiments of the invention;

FIG. 3 is a schematic diagram showing how embodiments of the invention split processing resources into a grid routing layer and a processing layer;

FIG. 4 is a schematic diagram showing how sell and availability requests are decoupled according to embodiments of the invention;

FIG. 5 is a schematic diagram showing how embodiments of the invention deploy remote availability spaces;

FIG. 6 is a flow diagram showing the main steps performed by an embodiment of the invention; and

FIG. 7 is a continuation of the flow diagram of FIG. 6 showing further steps which may be performed by an embodiment of the invention.

The following description is of a distributed inventory system for use in the aviation industry, but this is exemplary and other applications of the invention will also be discussed. For example, the inventory system may be used in the rail industry and coach travel industry. Further, embodiments of the invention may be advantageously used in any system where Revenue Management concepts are used, for example to sell a perishable commodity. Examples include, but are not limited to, inventory control systems for hotel rooms, car rentals, cruise lines, advertisement in television or radio during a time slot, or on the internet, electricity, gas or other utilities.

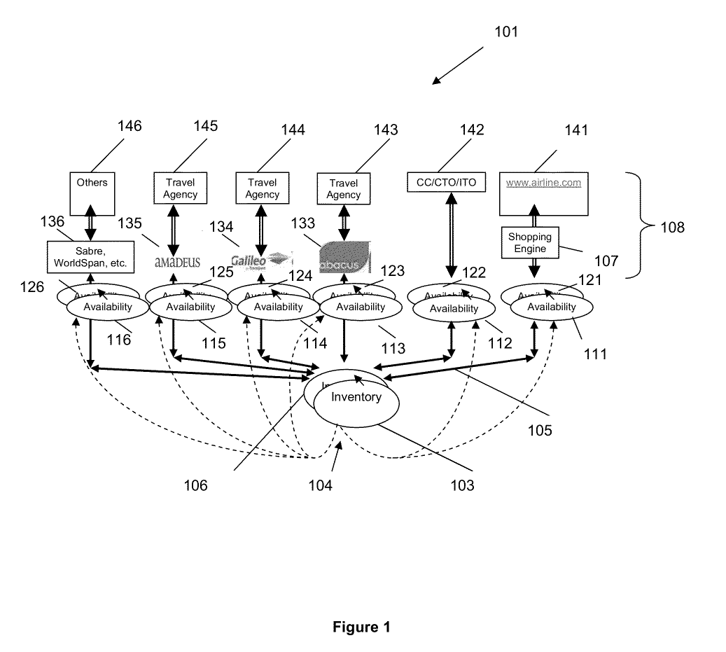

Referring now to FIG. 1, this shows a distributed inventory system 101 according to an embodiment of the invention. The system 101 is referred to as a Next Generation Inventory (NGI) system, and operates as a distributed inventory system as will be explained in further detail below.

The system has at least one main inventory system and one or more availability servers 111, 112, 113, 114, 115, 116. Although a single main inventory system is provided, the inventory system may reside on one or more computer nodes or servers 103, 106, as will be described in further detail below. The computer nodes or servers 103, 106 are usually located or deployed in a data centre.

Although not shown in FIG. 1, the inventory system comprises a database which stores inventory data. The database may be stored on an inventory computer or server. Preferably, embodiments of the invention use network accessible storage (NAS) devices.

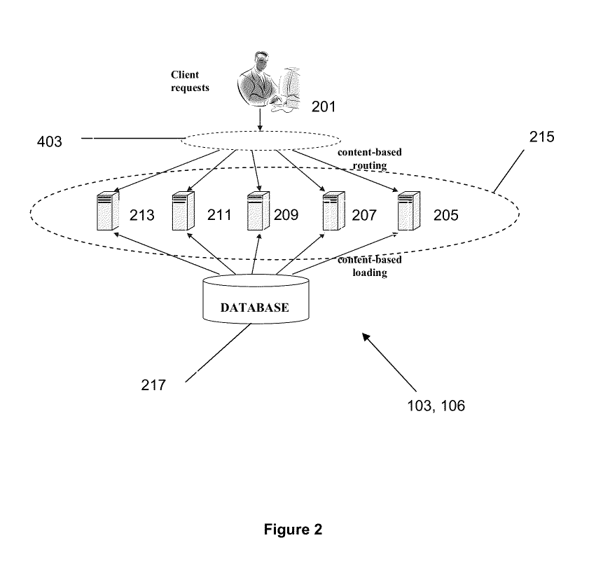

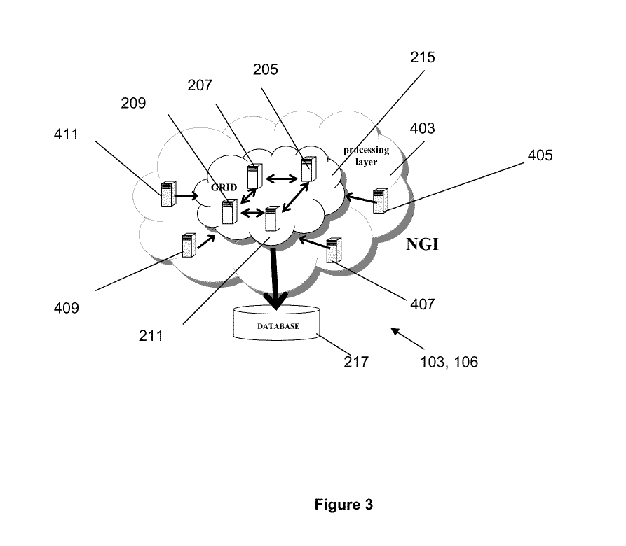

The inventory system 101 includes a processing layer, not shown in FIG. 1, as well as one or more grid nodes, also referred to as cluster nodes or server nodes. The grid nodes will be described in further detail below referring to FIG. 2 while the processing layer will be described in further detail below referring to FIG. 3. The grid nodes or servers 205, 207, 209, 211, 213 shown in FIG. 2 are also shown in FIG. 3, and are labelled with like reference numerals.

Each server or node 103, 106 can perform sell, cancel, availability and other inventory functions. Further, the servers or nodes 103, 106 may be remotely located from the one or more availability servers 111 to 116, and 121 to 126. For example the servers or nodes 103, 106 may be located in one region or area, while one or more availability servers may be located in a different region or area. In one example, the servers or nodes 103, 106 may be located in Atlanta while one or more availability servers may be located in Europe or Asia or both Europe and Asia. The availability server or servers may be located in close proximity to where the travel agency or other user making the availability request is located, for example, in the same city, or town, or state or country.

The inventory systems 103, 106 may be located in a data centre. Inventory data for each of the inventory nodes 103, 106 is stored in a database 217 shown in FIG. 2.

Availability Servers

It should be noted that the availability servers 111, 112, 113, 114, 115, 116 do not store a subset of the inventory stored in the inventory system. In contrast, as will be explained in further detail below, the availability servers calculate availability based on inventory control parameters and current inventory status which are broadcast at regular intervals from the main inventory system.

In the embodiment shown in FIG. 1, one or more further availability servers 121 to 126 are also be provided. However, these are in fact optional. These further availability servers 121 to 126 may be fail-over servers. A fail-over availability server is a redundant or standby server which can be used in the event that one or more of the availability servers 111 to 116 fail. Further, the data stored on the servers 111 to 116 and 121 to 126 may be stored in one or more partitions. Data may be partitioned in a number of ways. Data may be first partitioned at one level by airline. At a secondary level, data may be partitioned by Origin Destination or Market definition. The partition preferences may be changed if needed.

The availability servers 111 to 116 may be local availability servers which may be positioned in close proximity to where users requesting availability are located.

Alternatively, the availability servers 111 to 116 may be provided in any location, provided that they can communicate with the shopping engine 107 or airline or city ticket office 142 and the like via a WAN or LAN.

In one embodiment, the availability servers 111 to 116, 121 to 126, and servers 103, 106 may be physically deployed on a single physical server. For example, the single physical server may be logically split or partitioned in such a way that that the separate functions of the availability servers 111 to 116, 121 to 116, and servers 103, 106 can be performed on a single physical server.

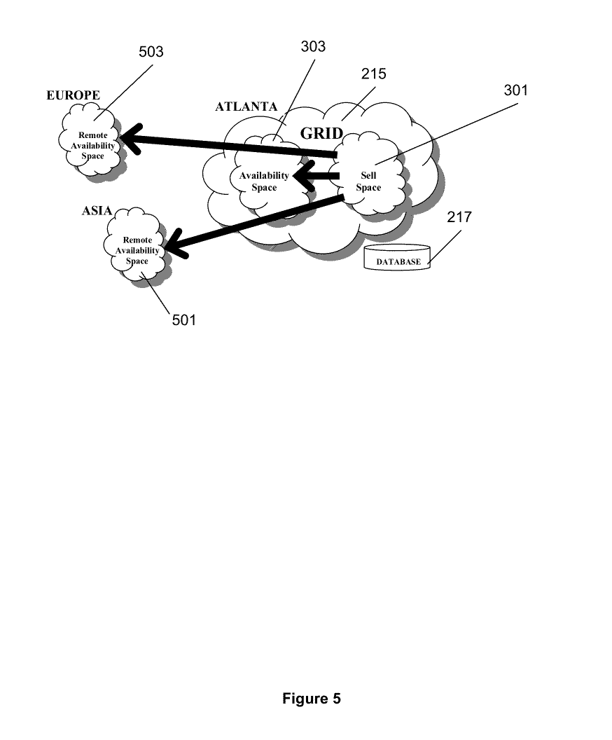

Alternatively, a separate physical server may be provided for each of the availability servers 111 to 116, 121 to 126, and servers 103, 106. In this case, availability servers 111 to 116 and 121 to 126 may be located in a different physical location to the servers 103 and 106. For example, one or both of servers 103, and 106, may be located in Atlanta, whereas one or more of the availability servers 111 to 116, 121 to 126 may be located in Europe or Asia. This feature will be described in further detail with reference to FIG. 5 below.

The availability servers 111 to 116, and 121 to 126 may perform availability functions only. Further, the availability servers 111 to 116, and 121 to 126 may be arranged to form a grid of availability servers. The servers 111 to 116, 121 to 126 may be communicatively connected with each other with a communication means to form the grid. Both the availability servers 111 to 116, 121 to 126 and servers 103, 106 may form part of the grid.

The grid may initially be deployed on computer servers or nodes 103, 106. Additional servers 111-116, 121-126 can be added to extend the grid to different locations. The grid allows the inventory system to have significant performance improvement compared to known inventory systems. However, it is important to note that total inventory solution is more than just the grid. However, the grid does allow embodiments of the invention to be highly scalable and run at higher performance so that frequent availability transactions can be efficiently processed.

One or more of the inventory servers 103, 106 is connected to each availability server 111 to 116, and 121 to 126 via a communication means. The communication means may be shared between the servers 111 to 116, and 121 to 126. In all cases, the communication means may be a network such as a LAN or a WAN.

Distribution Channel

The system 101 shown in FIG. 1 further comprises one or more inventory distribution channels 108. Each distribution channel 108 may include a global distribution system, otherwise referred to as a general distribution system, such as abacus 133, Galileo 134, Amadeus 135, Sabre or Worldspan 136 distribution systems. Usually, the global distribution systems 133, 134, 135, 136 do not include a CRS.

The distribution channels 108 allow an airline to distribute their inventory to the public. Further, each distribution system 133, 134, 135, 136 is connected via a communication means to one or more of the availability servers 111 to 116, and 121 to 126.

The main inventory system residing on servers 103, 106 may operate as a full inventory system without the need for the rest of the distributed systems, such as availability servers. For example, the main inventory system can function as an inventory system independent of the distributed inventory embodying the invention.

In the embodiment shown in FIG. 1, each distribution system 133, 134, 135, 136 is connected to an availability server 113 to 116. Preferably, each distribution system 133, 134, 135, 136 is also connected to further availability servers 123 to 126. Alternatively, each distribution system may be connected to a single availability server, although this configuration is not shown in FIG. 1.

The distribution channels 108 may also include an Airline website 141 connected to an availability server 111. The airline website 141 may be optionally connected to a further availability server 121. The distribution channels 108 may also include a call centre or city ticket office 142 connected to availability server 112. The call centre or city ticket office 142 may be optionally connected to a further availability server 122.

Further, the distribution channels 108 may also include a travel agency 143 connected to a Distribution system 133, a travel agency 144 connected to Distribution System 134, a travel agency 145 connected to Distribution System 135 and other agencies 146 such as Sabre, or WorldSpan connected to Distribution System 136.

For example, each of a Call Centre (CC) or City Ticket Office (CTO) or Issuing Ticket Office (ITO) 142 or airline website 131 may be directly connected to availability server 112 without the need to be connected to distribution systems 133, 134, 135, 136.

In this way, the City Ticket Office and the airline web site have direct access to the availability server of the inventory control system. Therefore, the distribution channels 108 are directly or indirectly connected to the availability servers 111 to 116, and 121 to 126 via a communications means. The communication means may be a network such as a Local LAN or a WAN. The connection between servers 111 to 116, and 121 to 126 and website 141, Call centre 142, travel agency 143, travel agency 144, travel agency 145, and others 146 is usually a wired connection

As shown in FIG. 1, the airline website 141 is connected via a shopping engine 107 to an availability server 111 and 121 without the need to access a distribution system 133, 134, 135, 136. Alternatively, the airline website 141 may be directly connected to the availability server 111,121 without the need for a shopping engine 107.

The function of the shopping engine 107 is to find seat availability on an availability server for a customer who makes a request for seat availability via an airline website. The shopping engine 107 may return seat availability which matches one or more user set criteria, such as price, time and date of flight and the like. Alternatively, instead of having a shopping engine, a shopping tool may be used to perform the function of the shopping engine.

The system 101 shown in FIG. 1 provides seat availability remotely by having one or more availability servers 111 to 116, and 121 to 126 which are integrated with the inventory servers 103, 106. As described in further detail below, this eliminates the need for each distribution channel to send an availability query to a central inventory system. All the availability queries are resolved locally using distributed availability servers 111 to 116, and 121 to 126.

As will be explained in further detail below, the system 101 provides an availability answer which has been calculated at the time of the processing by the system. The system then responds with an exact number of seats available. This is in contrast to prior art systems which may respond with wrong number of available seats, because for example, they use old cached availability answers. This means with prior art systems, a flight can appear as if it is closed, when in fact there are still seats available for sale. Similarly, when prior art systems use old cached availability answers, it can appear that the flight is open even though in reality, the flight is in fact closed for sale. In this way, the need for developing alternate availability solutions such as, AVS, AVN, Proxy, or cache is eliminated.

In order to keep the information on the availability servers 111 to 116, and 121 to 126 up to date, a sell space on server 103 or 106 broadcasts inventory data such as inventory control parameters and the current inventory status to the local availability servers 111 to 116, and 121 to 126. The inventory status indicates if a booking class on a flight segment is open or closed. The broadcasting of up-to-date inventory data from the servers 103 or 106 to one or more of the availability servers 111 to 116, and 121 to 126 is schematically shown in FIG. 1 by dashed arrows 104 pointing from the servers 103 or 106 towards the availability servers 111 to 116, and 121 to 126.

As previously explained, a single inventory system may run on multiple inventory servers 103, 106. One of these servers 103 or 106 may be allocated a sell space. It is the sell space on one of the servers 103, 106, which broadcast the changes to the availability space servers 111 to 116, and 121 to 126.

The broadcasting of inventory control parameters will now be described in further detail. Assume, for example, that an airline offers a non-stop flight from London to Malaysia, and that there are only 10 seats left on the flight. If the airline has to unexpectedly change the type of aircraft which will be used for the flight to a smaller aircraft, then this will cause the number of seats available on the flight to be reduced. With conventional inventory control systems such as those which use a cache based solution, this means that the inventory control system will incorrectly generate an availability answer based on the old cached availability answer. This will mean that the conventional inventory control system will incorrectly return the answer that there are 10 seats available on the flight, when in fact, because of the change of aircraft type to a smaller aircraft, less than 10 seats may be available. In the worst case scenario, such a conventional inventory control system might return an availability answer of 10 seats when in fact, no seats are available.

In order to solve this problem, the availability servers 111 to 116, and 121 to 126 receive a broadcast message from one of the inventory control systems 103, 106. The inventory control system 103 or 106 broadcasts an updated inventory control parameters and current inventory status to the availability servers 111 to 116 and 121 to 126.

The broadcast inventory control parameters may include data defining an aircraft type to be used for a flight. Additional inventory control parameters which may be sent from the servers 103, 106 to the availability servers 111 to 126, 121 to 136 include total number of seats, number of business class seats, number of first class seats, number of economy seats, and within each of these, the number of aisle seats and number of window seats. The broadcast inventory control parameters may also include a seat sold count, changes in the bid price, changes in the equipment type, and changes to booking limits by cabin, user defined rules that impact availability by POS. Further, the parameters which are sent in the broadcast inventory data may depend on the particular inventory control algorithm used by an airline.

The updates may be broadcast at a particular frequency. Further, the frequency with which the update is broadcast may be configurable. The frequency of the broadcast inventory data may be set by an airline depending on their preferences or may be based on network capacity or both network capacity and airline preferences. The messages may be broadcasted over the LAN or WAN.

Referring now to FIG. 2, this shows further detail of the distributed inventory system 101 shown in FIG. 1. FIG. 2 is a schematic diagram showing how data is partitioned among a number of grid nodes 205, 207, 209, 211, 213. The nodes 205, 207, 209, 211, 213 shown in FIG. 2 may be partitions of the availability servers 111-116, 121-126.

For example, a single grid node 205 may be provided on a single availability server 111, and a single grid node 207 may be provided on availability server 112, and so on. Alternatively, a number of grid nodes 205, 209, 211, 213 may be provided on a single availability server 111. For example, the grid nodes 205, 207, 209, 211, 213 may be logical partitions of one or more of the availability servers 111 to 126.

The primary use of the grid 205, 207, 209, 211, 213 is limited to partitioning, routing, broadcasting, and transactional protection, where local caches retain the bulk of the data; the working data-set. Usage of the grid is reduced to an absolutely necessity only.

The grid nodes 205, 207, 209, 211, 213 include availability space only, and this will be explained in further detail with reference to how seat availability request are made, and also how sell requests are processed. The grid nodes 205, 207, 209, 211, 213 may be deployed together in the same location as a cluster 215 or individually at different locations. By cluster, we mean a group of servers in approximately the same location or which are connected together by the same LAN.

Each grid node 205, 207, 209, 211, 213 has a grid memory, not shown in FIG. 2. The grid memory is usually a random access memory (RAM). In order to reduce the network traffic on the grid, some data is partitioned and some data are replicated across each grid node. Data that is replicated across all grid servers or nodes is small volume data which does not create memory issues when replicated. This data includes airline preferences, configuration parameters, and so on. Other data, as will be described in further detail below is partitioned across the grid nodes 205, 207, 209, 211, 213 so that each grid node handles availability requests based on the content of the availability request.

It should be noted that the main inventory systems 103, 106 may also receive availability requests which they have to process. This is in addition to the availability requests which are dealt with by the local availability servers 111 to 126. During initial setup of the inventory system, it is determined whether an availability request should be routed to one of the availability servers 111 to 116, 121 to 126 or to one of the servers 103, 106 forming the main inventory system. It is the processing logic determines whether an availability request is sent to one of the local availability servers 111 to 126 or one of the main inventory systems 103, 106. During deployment or integration time it is determined where the processing logic will run and therefore, where the transactions will be routed.

The client requests received by grid nodes 205 to 213 shown in FIG. 2 have the same format as the client requests received by one of the servers 103, 106 forming the main inventory systems. In this way, the same type of availability request can be received by local servers 111 to 126 or servers 103,106 forming the main inventory system in the data center depending on where the request is coming from. Availability requests are routed to the most logical servers, and this is determined during initial set up.

As will be explained in further detail below, the grid memory stores the most frequently used inventory data. Further, the data stored in the grid memory may be a copy of the most recently used inventory data stored in database 103. This avoids the need for each grid node 205 to 213 to request data from the database 217 each time one of the grid nodes 205 to 213 receives an availability request.

Usually, the database 217 is stored in one or more hard disk drives, associated with a database server. The database server is connected to each of the grid nodes 205, 207, 209, 211, 213 via a communication means. The communication means may be one of the communication means previously described.

Data stored in the grid memory is partitioned over the grid nodes 205, 207, 209, 211, 213. That is to say, each grid node 205, 207, 209, 211, 213 may store different data in its grid memory. For example, at least some of the data in each grid node does not need to be the same. The data stored in the grid nodes 205, 207, 209, 211, 213 may be partitioned by a key such as by an airline or by origin-destination of the availability request.

For example, it may be decided during initial set up that grid node 205 will handle all availability requests with an origin destination from AAA to BBC. In this way, when an availability request is received with an origin of Albuquerque, N. Mex., then the processing layer 403 examines the content of the request, determines that the request has an origin of Albuquerque. The processing layer examines the origin, and as the origin falls within the origin destination of AAA to BBC assigned to grid node 205, it routes the request to grid node 205. During initial set up of the system, one or more particular grid nodes are deployed on a particular availability server. This allows the system to route availability requests to particular availability servers which support grid nodes that handle that particular availability requests.

The routing decision may be made based on different criteria such as airline code, or OD city pair or some others. Preferably routing is based on Airline code only for small carriers. Routing may also be based on Airline code and OD city pair for large carriers. This is because larger carriers may need to further partition to be able to achieve the required system performance.

Similarly, grid node 207 may be assigned to handle availability requests with an origin-destination of BBD to CCC, while grid node 209 may be assigned to handle availability requests with an origin destination of CCD to DXX.

Furthermore, the grid nodes 205, 207, 209, 211, 213, and therefore, also the availability servers which support those grid nodes, are also connected via a communication means to a client 201, such as the travel agency 143, as shown by the arrows in FIG. 2 via a processing layer 403 including one or more processing servers. The function of the processing layer 403 will be described in further detail with reference to FIG. 3.

The availability servers 111 to 126 previously described, and grid nodes 205 to 213 may communicate with the processing layer 403 using a Java call. A Java application programming interface (API) may be used to allow external systems to access to the distributed inventory system 101. Once transaction is received, based on the transaction type and its content it is forwarded to the right node 205, 207, 209, 211 in the grid 215.

The most common transactions performed by embodiments of the invention are availability and sell transactions. Both the sell and availability transactions share a great deal in functionality. For example, each sell transaction requires an embedded availability calculation. This is necessary to make sure the seat shown in availability transaction is still available. This is due to the delay between availability and sell it is possible that the seat shown availability transaction might have been sold.

However, the determination of seat availability is a complex process which requires many resources as well as data including fares, fare-rules, legs, segments, flights, connections, cabins, influences, point-of-sale information, reservation booking designation (RBD) buckets, limit buckets, bid-prices, gradients, AVN or ANS info, etc. Nevertheless, putting aside the updates to “seat-sold” counts, which is a side-effect of sell transactions, availability transactions are, in theory, a read-only concept.

On the other hand, if the availability problem is solved, sell transactions require only updates to the seat-sold counts, needing only very limited resources such as cabin information. Further, the number of sell transactions is a small fraction of the availability transactions.

Further details of how the sell and availability transactions are handled by embodiments of the invention will now be described.

Availability Request Received by Local Availability Server

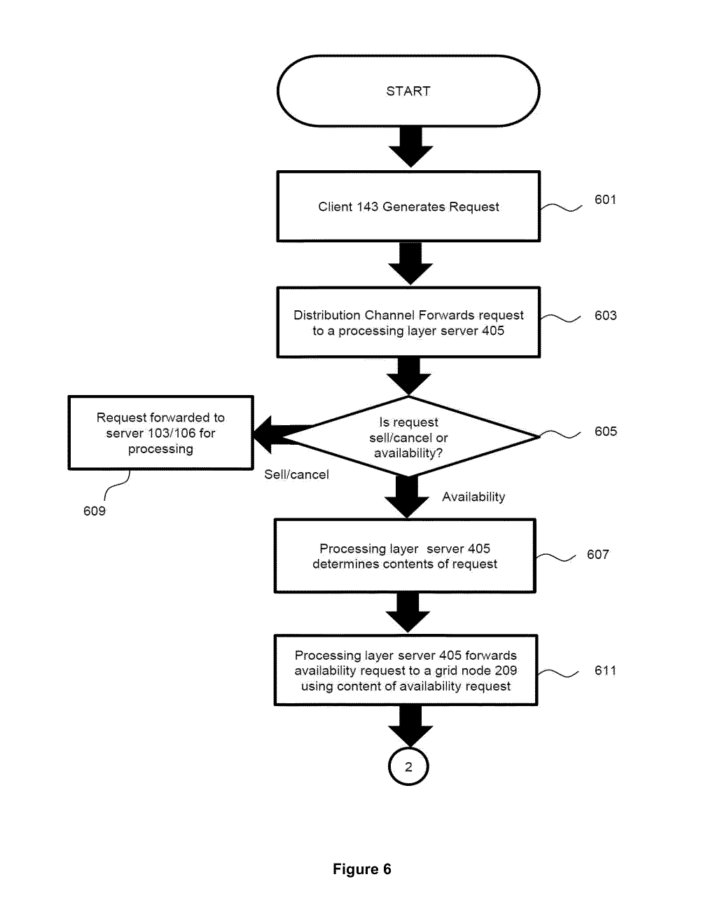

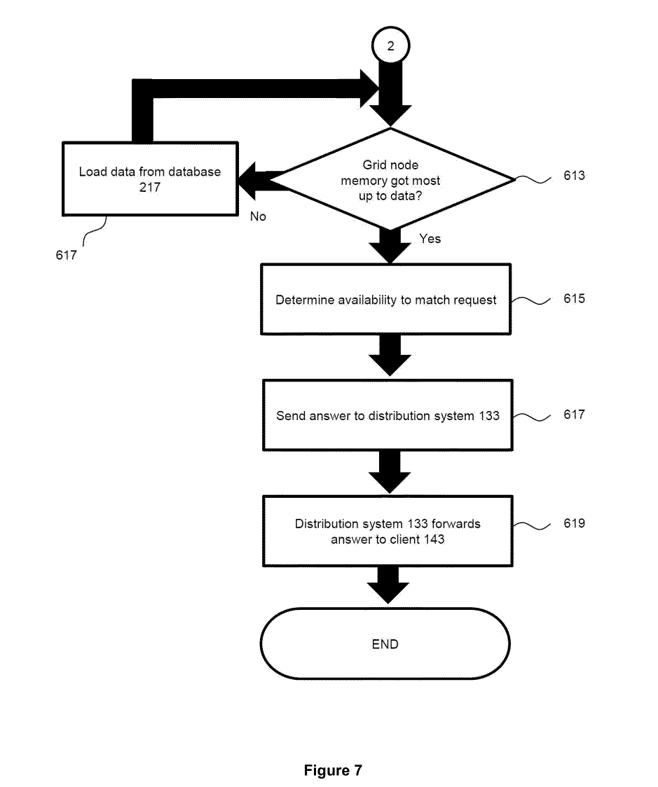

The main steps performed by an embodiment of the invention shown in FIGS. 1 and 2 when a seat availability request or transaction is received by one of the local availability servers 111 to 126 will now be described. Reference will also be made to the flow diagram shown in FIGS. 6 and 7. In principle, it does not matter which server 111 to 126 an availability request is routed to since all availability servers may have up to date availability information as a result of the broadcasts from the main inventory systems 103, 106. However, in practice, it does not make sense to use a server in Europe to service a customer in Asia. For example, during set up of the system, it may be decided to route all availability requests received from travel agency 143 via the abacus distribution system 133. In this way, the system is set up so that a travel agency uses a distribution system which is closest to it to maximise system performance.

A client, such as travel agency 143, generates an availability request at step 601. The travel agency 143 then sends the request to its distribution system 133. The distribution system 133 then forwards the request on to the processing layer 403, at step 603. The processing layer 403 comprises one or more processing layer servers, which are described in further detail below referring to FIG. 3. The processing layer 403 determines that the transaction is an availability transaction by looking at the content of the request. If the processing layer 403 determines at step 605 that the request is a sell or cancel request, then the request is forwarded to server 103 or 106 for processing at step 609, and this is described in further detail below under the heading “sell or cancel request”. If however, at step 605, the processing layer 403 determines that the request is an availability request, then the processing layer 403 forwards the request to availability server 123, at step 607.

FIG. 2 schematically shows how partitioned data and routed availability requests are matched on the grid nodes 205, 207, 209, 211, 213 by the processing layer 403.

The processing layer 403 routes the availability request to one of the grid nodes 205, 207, 209, 211, 211 using content based routing of, for example, the origin-destination of the availability request, as previously described. On occasions an availability request may be passed from one grid node to another grid node. However, as the routing decision is made before a transaction arrives to a grid node, this rarely occurs.

At least some of inventory data is partitioned between grid nodes 205, 207, 209, 211, 213 based on a key, as previously described. For example, some inventory data is stored in a grid memory which is associated with a particular grid node. The key may be an origin destination key, although the data may be partitioned using other keys such as airline, or date range. As described in further detail below, the processing layer determines which grid node the availability request should be routed to based on a search key. If the search key matches the key which is used to partition the data on a particular grid node 205 to 213, then the request is routed to that grid node.

In this way, routing of requests minimizes the need for data traffic in-between grid nodes 205, 207, 209, 211, 213. The partitioned data is stored on a grid memory associated with one of the nodes 205, 207, 209, 211, 213. The grid memory stores a subset of the data stored in the database 217. Usually the subset of data is the most recently requested data from the database 217.

For example, if the availability request relates to a flight originating from Denver, then, the processing layer 403 determines that the origin of the availability request relates to Denver at step 607 and routes the availability request to node 209 which handles availability requests for origin destinations CCD to DXX, at step 611.

The grid node 209 then checks that it has the most up to date data in the grid memory, at step 613. If the data in the grid memory is not the most up to data, then the grid nodes 209 requests the main inventory system to send that data to the grid node 209, at step 617, as shown by the arrow pointing from the database 217 towards the grid node 209 in FIG. 2, and by arrow 105 shown in FIG. 1.

Alternatively or in addition, at step 613, a determination may be made as to whether the required data is available from the grid memory. This may be because the grid may not know if it has the complete set of data required in the grid memory. In this case, the grid node in question may have to go to the database 217 to retrieve the data.

For example when all the fares needed for a given market are required, the grid node does not know if all the fares are already stored in the grid memory. Therefore, the grid node interrogates the database 217 in order to obtain this information. However, this, in turn, does increase the response time. Embodiments of the invention preferably avoid this type of request from the grid that increases access to the database. The data in the grid memory is replaced with new data from the database as needed.

The data stored in the grid memory on the grid node 209 includes the most recent inventory control parameters and current inventory status broadcast by the main inventory system.

If, on the other hand, it is determined at step 613 that the grid node 209 has the most up to date data or/and the grid node has all the required data, then, the grid node 209 then determines seat availability at step 615 by using the data stored in the grid memory on grid node 209.

Once the grid node 209 has determined whether seats are available matching the availability request, then it returns the answer to the distribution system 133 at step 617, which in turn forwards the answer to travel agency 143 i.e. client 201 at step 619. The process may then be repeated for further availability requests, which of course, may be received from different clients such as travel agency 144, travel agency 145, or other clients 146. Further, as explained above, each client may use a different distribution channel 108, and each availability request may be routed via a different availability server depending upon initial configuration of the system. Further, since each availability request can in principle be different, depending upon the contents of the availability request, subsequent availability requests may be routed via a different grid node 207, 209, 211, 213 as previously described.

In this way, the grid servers 205, 207, 209, 211 within the grid 215 perform processes which are required to run at the highest possible speed, such as availability requests. Therefore grid usage is reserved for work which requires shared-resources, such as availability transactions. Therefore the availability functions are performed by one of the grid nodes 205, 207, 209, 211, 213 forming the grid 215.

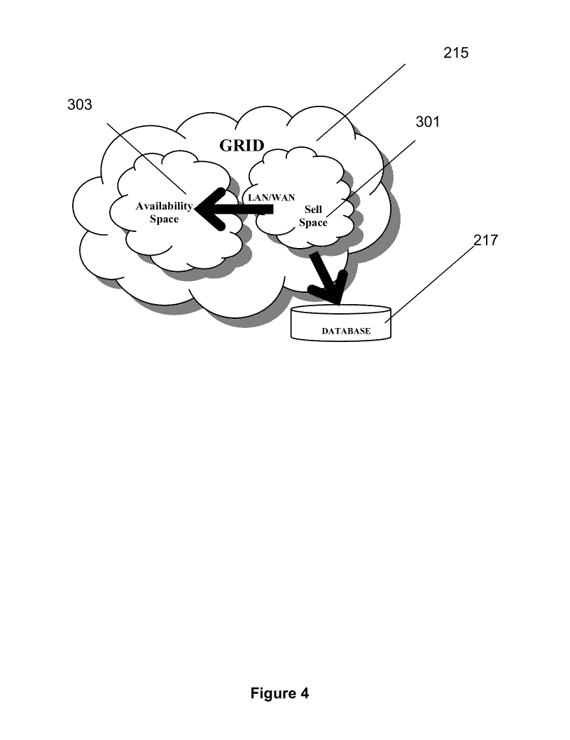

The remaining processes, such as the schedule change, connections, etc. are pushed onto the one of the processing nodes (i.e. servers 405, 407, 409, 411 shown in FIG. 4) without consent. Tapping into processing nodes 405 407 409 411 resources in the processing layer allows for additional central processing unit power to be provided. This, in turn, minimises the usage of grid 215 which allows the grid to serve more clients. All clients, such as airline 141 city ticket office 142, travel agency 143, 144, 145 and others 146 access the processing layer 403 via a service referred to as an NGI-proxy.

Routing availability requests via one of the grid nodes 205, 207, 209, 211, 213 avoids accessing distributed objects over the cluster 215, such as revenue management controls, schedules, route, and so on which are used when an availability calculation is made.

Nevertheless, the integrity of the grid data stored on the grid nodes 205, 207, 209, 211, 213 must be protected for other potential users. Therefore, the grid servers 205 to 213 do not furnish the original copy of an object, such as revenue management controls, schedules, route, and so on upon request; rather, they clone the object even if the client needs no update on the object. This is because cloning can take a toll on garbage collection in such systems. Embodiments of the invention avoid this by utilizing local caches and object managers layered over the grid.

In this way, embodiments of the invention may be implemented in a programming style to avoid generating garbage to the maximum extent possible. Some programming languages, such as Java, use garbage collections. This is an automatic Java function which is executed in order to maintain the data integrity, and to remove data which is marked as unwanted. When the garbage collection starts it can have a significant impact on the system performance. Embodiments of the invention therefore avoid unnecessary garbage creation. By avoiding creating garbage, garbage collections can be less frequent, thereby improving system performance compared with prior art systems.

### Sell or Cancel Request

The steps performed by embodiments of the invention when routing a seat sell or cancel request, will now be described with reference to FIGS. 1 to 3. A sell transaction is, in general, a relatively slow and infrequent transaction, while an availability transaction is faster and more frequent than the sell transaction. The sell or cancel requests are handled by servers 103 or 106 forming the main inventory system so that the availability servers 111 to 126 are not slowed down by having to perform sell or cancel requests.

The speed and frequency of the sell and availability transactions depends on the look to book ratio. This is defined as the number of availability transactions which generate a single sell transaction. The look to book ratio is around 200:1 in the US, 400:1 in Europe, and 1000:1 in the Far East. The frequency of the sell and availability transactions is closely related to the business process of the airline in question, and to the source of the transactions. For example, automated web sited tend to create very high volume transactions.

FIG. 3 shows how embodiments of the invention may also be implemented a two-tiered approach in which the system is divided into a grid 215 where contentious resources are shared and where availability requests are handled, and a processing layer 403, which decides where a sell or availability request should be handled, either using the processing layer 403 if the request does not require high performance response time, such as a sell or cancel request or using one of the grid nodes 205 to 213 if the request has high performance requirements such as an availability request.

Therefore, the processing layer 403 handles work, without needing any grid resources. The processing layer 403 comprises one or more servers 405, 407, 409, 411 which either route requests to the grid or process those requests itself. The servers 405, 407, 409, 411 process the slower sell transactions.

The servers 405, 407, 409, 411 support a number of services, such as availability services, a sell service, and a cancel service. How these services are defined determines how availability request, sell requests and cancel requests are dealt with at the processing layer.

The processing layer servers 405, 407, 409, 411 define a number of services which can be looked up or accessed by using one of the servers, in an analogous way to which a business or telephone directory can be used to search for a particular business service or person. For example, clients, such as travel agency 143 to look up services provided by the processing layer servers, such as a sell request, and send it to one of the servers in the processing layer in the format required by the processing layer servers. This is accomplished via a Service Bus. The calling systems do not necessarily need to know where each server resides. The services are automatically identified by the Service Bus.

When a sale occurs, the servers 103, 106 are kept up to date in the following way. For example, an up-line system, such as a travel agency 144 requests the sale and sends the transaction to the Galileo GDS 134.

The distribution system 134 then forwards the sell request to one of the servers 405, 407, 409, 411 in the processing layer 403. A Service Bus may link the servers 405, 407, 409, 411 so that a request can be correctly transferred from one of the distribution channels 108 to any available processing layer server 405, 407, 409, 411. One of these servers in the processing layer 403 analyses the contents of the request and determines that the request is a sell transaction. As the request is a sell request, one of the servers 405, 407, 409, 411 then forwards the transaction to one of the computer nodes or servers 103 or 106 supporting the main inventory system. If the request had been an availability request, then the contents of the request would have been determined by the processing layer and request would have been forwarded to the relevant grid node as previously described referring to FIG. 6.

The sell service of the main inventory system then requests one of the availability servers 111 to 126 or 103, 106 to calculate the availability with the most recent information received in the broadcast from one of the sell servers 103, 106. This availability check is performed just before a sell transaction is completed, to check that there is still availability to meet the availability request, as previously described. This checks that there is still seat availability which matches one or more parameters included in the sell request, such as price, airline, origin and destination etc. to make sure a future sale is only allowed if there is still availability for the requested fare class.

The availability server then forwards the transaction back to the sell service for processing. An acknowledgement that the sell transaction has been completed is then sent back, via the Galileo GDS 134 to the travel agency 144. In response to the sale, data is updated in the following way, depending upon the performance requirements.

For example, supposing that a seat has been sold, and the database 217 needs to be updated to take this into account. Prior art inventory systems lock the database until the data is updated. This means that there is a bottle neck because availability services cannot respond until the database is updated.

Embodiments of the invention solve this problem by asynchronously writing data to the database. For example, supposing the seat sold count in database 217 needs to be updated to take into account there is only one seat left on a particular flight. This is important, since subsequent availability requests will only return the correct seat availability if the database has been correctly updated.

Instead of updating the data in database 217, the server 405 sends a request to one of the servers 205, 207, 209, 211 in the grid to update the seat sold count in the grid memory. Data stored in the grid memory is partitioned over the grid nodes 205, 207, 209, 211, 213 as previously described. The grid memory is also updated with a flag which indicates whether the seat sold count data in the grid memory is more up to date than the seat sold count in the database. In this way, subsequent availability requests which are received by the system before the data in the database has been updated, check the flag stored in the grid memory to determine which is the most up-to-data of the data stored in the grid memory or database, and access the most up to data to perform the availability calculation.

The data in the database is updated with the data stored in the grid memory a short delay However, in some cases, data is first updated in the database, and then subsequently the grid memory is updated with the most up to date data.

For example, suppose a bid price is received from a revenue management system. It is acceptable for this data to arrive to grid with some delay. This is why data it is first updated in the database and then broadcasted to the grid later.

In this way, the method of recording data depends on the performance needs. Data that does not require high performance is written to the database directly by the processing layer first and then broadcasted to the grid later. However, data which is critical to the availability calculation (such as seat sold count) is written to the grid memory first then writing to the data base asynchronously.

In one embodiment, data is sent to server 103 storing the database, rather than to both servers 103, 106. The server 103 regularly updates database stored on server 106, so that server 106 acts as a fail-over server. The fail-over server 106 is a redundant or standby server which can be used in the event that the server 103 fails.

In an alternative embodiment, data is sent both to servers 103 and 106. Data is routed to either server 103 or sever 106 based on the content of the data being sent. In this way, the database is partitioned across servers 103 and 106. This configuration has the advantage that the parallel servers 103 and 106 have more capacity to handle any potential increase in traffic.

In both cases, in the event that one of the servers 103, 106 fails, an additional new server can be added to the inventory system so that there is always at least a single fail-over server which can be used in case one of the servers 103 or 106 fail.

Referring now to FIG. 4, this diagram shows a logical picture of how sell and availability functions (i.e. sell and availability transactions) are separated or decoupled from each other. Although the sell space 301 and the availability space are logically separated, the sell space 301 and the availability space 303 may reside on a single node or server. The node may be any one of the nodes 205, 207, 209, 211, 213.

Decoupling the availability and sell transactions is achieved by having an application which has availability and sell transactions as a loosely coupled set of services. As such, availability service is not limited with the disk I/O required by a sell transaction.

However, there still needs to be a link between the sell transactions and the availability transactions and so each Sell transaction needs to update the information needed for Availability calculation when a Sell has occurred, as previously described. This is accomplished as previously described via a custom conveyor limited to a single network broadcasting message. The availability space may be kept up-to-date with sell transaction via low-frequency bulk updates from the sell space. The updates may be sent once a second. This keeps the network usage at a minimum. The updates are schematically shown in FIG. 4 with an arrow pointing from the sell space 301 to the availability space 303.

However, it should be noted that the availability space 303 does not send any updates to the sell space 301. This is because availability is a read only process, and as such it does not update any data. Therefore, the sell and availability transactions can be said to be asymmetric since performing a sell or cancel transaction requires the availability space 303 to be updated, whereas performing an availability transaction does not require the sell space 301 to be updated.

In this way, the availability transactions are sent more quickly than slower sell transactions because they are largely decoupled from the availability transactions.

Embodiments of the invention also reduce or eliminate distributed transactions. Distributed systems eventually incur and suffer a distributed-transaction cost. This is a heavy price to pay in performance, or results in a compromise in transactional integrity.

Embodiments of the invention do not suffer from these problems. This is achieved by localising all read or write objects in a single partition, therefore avoiding distributed transaction cost. However, it still conveys the correct information to the remaining nodes and keeps transactional integrity intact.

Embodiments of the invention also reduce the number of, or avoid local transactions. However, the updating objects in the grid 215 needs to be transactional. A Local transaction is a request which one node sends to another node. These are required in certain circumstances that require internal communication between nodes. These local transactions are minimized in order to minimise network delays.

Embodiments of the invention achieve this by using a dedicated object manager over the grid 215, and by using dedicated object caches.

Grid or server nodes availability eventually needs to be updated with the most recent seat-sold information. This is broadcast from the sell space 301. When an availability request arrives and if it is in collision path with a transactional update, requests and updates are handled within the local cache before a transactional update to the grid is made. This results in no slow-down in service execution. Even though the local grid updates maintain transactional integrity, service requests sustain no deterioration by such transactional updates.

Embodiments of the invention also have availability which is distributed over a Wide Area network. Embodiments of the invention achieve this by separation of availability transactions from sell transactions by having the sell transactions confined to the sell space 301 and the availability transactions confined to the availability space 303, and using a mechanism to update availability in much slower frequencies and in-bulk, makes it possible to deploy multiple, independent, remote availability spaces.

Embodiments of the invention which separate availability and sell allow the deploying of remote availability spaces where they are needed the most for example at GDSs, big airlines, and the like. It reverses the network traffic: availability transactions become local, they are deployed where they are needed and cheap; and updates to availability spaces are low-frequency, in-bulk, and extremely efficient and low-cost.

FIG. 5 shows an embodiment of the invention including deployment of remote availability spaces, and the reverse traffic from the central grid to remote spaces.

FIG. 5 is similar to FIGS. 3 and 4, and so like features have been given like reference numerals, and will not be described again in detail. However, the embodiment shown in FIG. 5 has local deployments in Europe 503 and Asia 501 and provides availability answers locally thereby avoiding those transactions being sent to a remote server location, such as Atlanta.

This deployment not only provides correct availability answer locally, but also creates significant cost savings by eliminating the cost of sending availability transactions to Atlanta. Depending on the look to book ratio, the cost savings may be very significant because the amount of data pushed from Atlanta to Asia and Europe is significantly less than availability transactions eliminated.

In summary, embodiments of the invention provide the ability to distribute real-time or seamless availability to remote locations, across the WAN, without the high volume of availability requests coming directly to the CRS.

This eliminates type 1 and type 2 errors associated with proxy, AVS or AVN messaging and cache solutions previously described. A type 1 error occurs when an availability request says there are seats available for a given product type, but in fact there is none, thus sell cannot be successfully processed. A type 2 error occurs when an availability request says there is no seat available for a given product, but in fact there are seats available, consequently airlines loses a potential sale opportunity.

Embodiments of the invention scale to multiple locations. For example, if a particular solution is adopted by one customer, it can easily be converted for use by another customer because it is easy to quickly deploy a new grid at each GDS.

1. An inventory control system comprising:
an inventory server for storing inventory parameters defining one or more products;
an availability server arranged to receive an availability request for a product;
broadcasting means for broadcasting updated inventory parameters from the inventory server to the availability server;
wherein the availability server determines the availability of the requested product by comparing one or more product parameters to one or more inventory parameters in response to the availability server receiving an availability request.

2. An inventory control system according to claim 1 in which the availability server is configured to perform an availability request and not a sell request for a product and preferably in which the inventory server is configured to perform both sell and availability requests.

3. An inventory control system according to claim 1 in which the inventory server is communicatively coupled to the availability server in real time via a network such as a Wide Area Network or a Local Area Network.

4. An inventory control system according to claim 1 in which a plurality of availability servers are provided for performing an availability request and not a sell request.

5. An inventory control system according to claim 1 further comprising a distribution server, for example an airline server, or a call centre server or a city ticket office server, wherein the availability server and the distribution server are provided on a single server.

6. An inventory control system according to claim 1 in which the availability server is logically separated from the inventory server, and in particular in which the availability server is in a different location to the inventory server.

7. An inventory control system according to claim 1 further comprising one or more additional availability servers each arranged to receive a or the availability request and in particular to determine the availability of a product by comparing one or more product parameters to one or more inventory parameters in response to one of the availability servers receiving an availability request.

8. An inventory control system according to claim 1 in which the availability server further comprise one or more grid nodes.

9. An inventory control system according to claim 8 in which each grid node comprises a grid memory.

10. An inventory control system according to claim 8 in which the availability request is routed via one of the grid nodes in dependence upon the content of the availability request.

11. An inventory control system according to claim 8 in which at least some of the grid nodes are located on different availability servers.

12. An inventory control system according to claim 9 wherein each grid memory stores one or more inventory parameters of the most recent availability request received by the grid node.

13. An inventory control system according to claim 9 in which each grid memory stores at least some inventory parameters which are different from the inventory parameters stored in the other grid memories.

14. An inventory control system according to claim 9 in which the inventory parameters are sent from the inventory server to one of the grid memories if the inventory parameters of the requested product are not stored in the grid memory or are not the most up to date parameters.

15. An inventory control system according to claim 14 in which the inventory parameters are routed to one of the grid memories in dependence upon the content of the availability request.

16. An inventory control system according to claim 1 further comprising an updating means arranged to asynchronously update the inventory parameters stored in the inventory server (103) and the inventory parameters stored in one of the grid memories.

17. An inventory control system according to claim 16 in which the updating means first updates the data stored in one of the grid memories and then the inventory parameters stored in the inventory server if a sell or cancel transaction is received by one of the inventory server.

18. An inventory control system according to claim 16 in which the updating means first updates the inventory parameters stored in the inventory server and then the data stored in one of the grid memories if the inventory server receives bid price data or schedule connection data or fare data or business rule data.

19. An inventory control system according to claim 1 further comprising one or more processing servers for receiving a request and in particular for determining the type of request.

20. An inventory control system according to claim 1 in which the inventory server is logically or physically or both logically and physically separated from the availability server.

21. An inventory control system according to claim 1 further comprising one or more additional inventory servers.

22. An inventory control system according to claim 21 in which the inventory parameters are partitioned across the inventory servers such that each inventory server stores at least some inventory parameters which are different from the inventory parameters stored on the other server.

23. An inventory control system according to claim 21 in which one inventory server is a fail-over server for the other inventory server, the fail-over server storing a copy of the inventory parameters stored on the other inventory server.

24. An inventory control system according to claim 19 in which one of the processing servers only routes the request to one of the grid nodes if the request is an availability request.

25. An inventory control system according to claim 19 in which one of the processing servers routes a request to the inventory server if the request is a sell or cancel request.

26. An inventory control system according to claim 1 in which the product parameters are compared with updated inventory parameters.

27. An inventory control system according to claim 1 further comprising one or more additional fail-over servers.

28. An inventory control method comprising:
storing inventory parameters on an inventory server;
receiving on an availability server an availability request for a product;
broadcasting using broadcasting means updated inventory parameters from the inventory server to the availability server;
wherein the availability server determines the availability of the requested product by comparing one or more product parameters to one or more inventory parameters in response to the availability server receiving an availability request.

29. An inventory control method according to claim 28 in which the availability server is logically separated from the inventory server, and in particular in which the availability server is in a different location to the inventory server.

30. An inventory control method according to claim 28 further comprising one or more additional availability servers each arranged to receive a or the availability request and in particular to determine the availability of a product by comparing one or more product parameters to one or more inventory parameters in response to one of the availability servers receiving an availability request.

31. An inventory control method according to claims 28 in which the availability server further comprise one or more grid nodes.

32. An inventory control method according to claim 31 in which each grid node comprises a grid memory.

33. An inventory control method according to claims 31 in which the availability request is routed via one of the grid nodes in dependence upon the content of the availability request.

34. An inventory control method according to claim 31 in which at least some of the grid nodes are located on different availability servers.

35. An inventory control method according to claim 32 wherein each grid memory stores one or more inventory parameters of the most recent availability request received by the grid node.

36. An inventory control method according to claim 32 in which each grid memory stores at least some inventory parameters which are different from the inventory parameters stored in the other grid memories.

37. An inventory control method according to claim 32 in which the inventory parameters are sent from the inventory server to one of the grid memories if the inventory parameters of the requested product are not stored in the grid memory or are not the most up to date parameters.

38. An inventory control method according to claim 32 in which the inventory parameters are routed to one of the grid memories in dependence upon the content of the availability request.

39. An inventory control method according to claim 28 further comprising an updating means arranged to asynchronously update the inventory parameters stored in the inventory server and the inventory parameters stored in one of the grid memories.

40. An inventory control method according to claim 39 in which the updating means first updates the data stored in one of the grid memories and then the inventory parameters stored in the inventory server if a sell or cancel transaction is received by one of the inventory server.

41. An inventory control method according to claim 39 in which the updating means first updates the inventory parameters stored in the inventory server and then the data stored in one of the grid memories if the inventory server receives bid price data or schedule connection data or fare data or business rule data.

42. An inventory control method according to claim 28 further comprising one or more processing servers for receiving a request and in particular for determining the type of request.

43. An inventory control method according to claim 28 in which the inventory server is logically or physically or both logically and physically separated from the availability server.

44. An inventory control method according to claim 28 further comprising one or more additional inventory servers.

45. An inventory control method according to claim 44 in which the inventory parameters are partitioned across the inventory servers such that each inventory server stores at least some inventory parameters which are different from the inventory parameters stored on the other server.

46. An inventory control method according to claim 44 in which one inventory server is a fail-over server for the other inventory server, the fail-over server storing a copy of the inventory parameters stored on the other inventory server.

47. An inventory control method according to claim 44 in which one of the processing servers only routes the request to one of the grid nodes if the request is an availability request.

48. An inventory control method according to claim 44 in which one of the processing servers routes a request to the inventory server if the request is a sell or cancel request.

49. An inventory control method according to claim 28 in which the product parameters are compared with updated inventory parameters.

50. An inventory control method according to claim 28 further comprising one or more additional fail-over servers.

51. A computer program product which when loaded onto a computer executes the method of claim 28.
